(19) United States
(12) Patent Application Publication
(10) Pub. No.: US 2008/0146234 A1
(43) Pub. Date: Jun. 19, 2008

(54) APPARATUS AND METHOD FOR PROVIDING HANDOVER INFORMATION IN MOBILE COMMUNICATION SYSTEM

(75) Inventor: Jong-Yol KIM, Seongnam-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/960,081

(22) Filed: Dec. 19, 2007

(30) Foreign Application Priority Data
Dec. 19, 2006 (KR) 2006-0129871

(51) Int. Cl. H04Q 7/20

(52) U.S. Cl. 455/437; 455/436

(57) ABSTRACT

Provided is a method for performing a handover of a subscriber station having a Digital Multimedia Broadcasting (DMB) wireless communication interface and a plurality of wireless communication interfaces for a plurality of mobile communication systems. In method, wireless communication with one of the mobile communication systems is performed using the corresponding wireless communication interface. Network information for a handover to the mobile communication systems is obtained from a DMB channel during the performing of the wireless communication. If the wireless communication with one of the mobile communication systems is impossible, the network information is analyzed to select the best mobile communication system as a handover target.

### PRIORITY

This application claims priority under 35 U.S.C. §119(a) to an application filed in the Korean Intellectual Property Office on Dec. 19, 2006 and assigned Serial No. 2006-0129871, the contents of which are incorporated herein by reference.

### BACKGROUND OF THE INVENTION

1. Field of the Invention

The present invention relates generally to providing network information for a handover between different networks, and in particular, to an apparatus and method for performing a handover from a wireless communication system to another wireless communication system when the wireless communication system is unavailable, by providing inter-network handover information over a Digital Media Broadcasting (DMB) channel to a Subscriber Station (SS) that has a plurality of interfaces for a Broadcast Wireless Access (BWA) communication system using the Institute of Electrical and Electronics Engineers (IEEE) 802.16e, a mobile communication system using wireless communication protocols such as Code Division Multiple Access (CDMA), Global System for Mobile communications (GSM) and Wireless Fidelity (WiFi), and a Digital Multimedia Broadcasting (DMB) system.

2. Description of the Related Art

Extensive research is being conducted to provide various Quality of Service (QoS) features with a data rate of about 100 Mbps in the advanced fourth-generation (4G) communication system. The 4G communication system is evolving to provide mobility, a high data rate transmission, and a high QoS in a Broadcast Wireless Access (BWA) communication system such as a Wireless Local Area Network (WLAN) system and a Wireless Metropolitan Area Network (WMAN) system. Typical examples of the above system are identified in the Institute of Electrical and Electronics Engineers (IEEE) 802.16d system and the IEEE 802.16e system standards. Worldwide Interoperability for Microwave ACCess (WiMAX) or Wireless Broadband (WiBro) uses the communication technologies of IEEE 802.16d and IEEE 802.16e.

The IEEE 802.16d system and the IEEE 802.16e system use an Orthogonal Frequency Division Multiplexing (OFDM)/Orthogonal Frequency Division Multiple Access (OFDMA) scheme to provide a broadband transmission network for a physical channel of the WMAN system. The IEEE 802.16d system considers only a fixed Subscriber Station (SS) and a single cell structure (i.e., the mobility of an SS is not considered). The IEEE 802.16e system considers the mobility of an SS.

There is a case where an SS must change Base Stations (BSs) during movement. In this case, the SS is handed over from a BS to another BS.

FIG. 1 is a diagram illustrating a network configuration of a conventional IEEE 802.16e system. WiBro is one of the wireless communication technologies using the IEEE 802.16e standard. Hereinafter, a wireless communication system using the IEEE 802.16e standard will be referred to as a “WiBro system”.

Referring to FIG. 1, a WiBro Personal Subscriber Station (PSS) 120, which is an example of a subscriber station, performs wireless communication with a Radio Access Station (RAS) 125. The Transmission (TX) data of the WiBro PSS 120 is transmitted through an Access Control Router (ACR) 130 to an external network. The ACR 130 also manages the RAS 125.

A Network Management System (NMS) 110 is a central monitoring system capable of managing all the devices on the network. For example, the NMS 110 monitors in real time status data, failure data, configuration data, and statistical data on the network elements. Also, the NMS 110 controls the amount of available traffic according to priority, and informs an operator when a failure occurs, for rapid treatment of the failure. In addition, on the basis of collected data, the NMS 110 provides information necessary for analysis of the current network and establishment of the upcoming network strategy.

According to the trend of convergence between broadcasting and communication, an SS employing both the WiBro technology and the DMB technology is being developed and introduced. The DMB technology includes the Moving Picture Experts' Group (MPEG)-4 technology and the BInary Format for Scenes (BIFS) technology. The BIFS is technology for an interactive real-time video data service or a synchronized data broadcasting service. For reference, the existing terrestrial DMB standard specification is based on the Eureka-147 specification, i.e., the European Digital Audio Broadcasting (DAB) specification, from which the BIFS specification has been proposed.

When an SS employing both the WiBro technology and the DMB technology is used to enjoy an Internet Protocol TeleVision (IPTV) service based on a Multicast Broadcast Service (MBS) of the WiBro, if a user of the SS enters a region where a WiBro signal is too weak for reception, the user cannot continue to enjoy the IPTV service.

In this case, if information about a WiBro service area is received, beforehand, through the DMB technology capable of providing a larger coverage than the WiBro technology, the SS can seamlessly convert a WiBro-based IPTV service into a DMB-Based digital broadcasting service, thereby making it possible to provide a better service for the user.

There is a case where, while enjoying a WiBro data service, a user of an SS, which is provided with a complete WiBro interface, interfaces with different communication networks (e.g., CDMA, GSM, Enhanced Data Rates for GSM Evolution (EDGE), General Packet Radio Service (GPRS), Wireless CDMA (WCDMA), WiFi, and High-Speed Downlink Packet Access (HSDPA)), and a DMB interface, moves into a region where the WiBro data service is unavailable but another network data service is available. In this case, if the entire network information is beforehand or periodically provided over a DMB-based BIFS data channel, a corresponding handover can be performed seamlessly and more effectively.

However, there is no definition of inter-working between the WiBro network, the different communication networks, and the DMB network. What is therefore required is such an inter-working technology.

### SUMMARY OF THE INVENTION

An aspect of the present invention is to substantially solve at least the above problems and/or disadvantages and to provide at least the advantages below. Accordingly, an aspect of the present invention is to provide an apparatus and method for providing handover information in a mobile communication system.

Another aspect of the present invention is to provide an apparatus and method for performing a handover from a first wireless communication system to another wireless communication system when the first wireless communication system is unavailable, by providing inter-network handover information to a subscriber station that has a plurality of interfaces for communication systems using different wireless communication protocols.

According to one aspect of the present invention, a method for performing a handover of a subscriber station having a DMB wireless communication interface and a plurality of wireless communication interfaces for a plurality of mobile communication systems includes performing wireless communication with one of the mobile communication systems using the corresponding wireless communication interface; obtaining network information for a handover to the mobile communication systems from a DMB channel during the performing of the wireless communication; if the wireless communication with one of the mobile communication systems is impossible, analyzing the network information to select a best mobile communication system as a handover target; and performing a handover to the selected mobile communication system.

According to another aspect of the present invention, a method for providing handover information to a network management system includes generating network information for a handover; and transmitting the handover network information to a digital broadcast encoding system.

According to still another aspect of the present invention, a method for providing handover information at a digital broadcast encoding system includes receiving network information for a handover from a network management system; converting the handover network information into a BIFS format; and transmitting the BIFS-format handover network information to a DMB transmitting system.

According to even another aspect of the present invention, an apparatus for performing a handover of a subscriber station having a DMB wireless communication interface and a plurality of wireless communication interfaces for a plurality of mobile communication systems includes a handover manager for obtaining network information for a handover to the mobile communication systems from the DMB wireless communication interface and, if wireless communication with the currently-connected mobile communication system is impossible, analyzing the obtained network information to select the best mobile communication system as a handover target to perform a corresponding handover; and a storage for storing the network information for a handover to the mobile communication systems.

According to yet another aspect of the present invention, an apparatus for providing handover information at a network management system includes an interface for communicating with another node; a handover manager for generating network information for a handover to a plurality of mobile communication systems and transmitting the generated handover network information to a digital broadcast encoding system through the interface; and storage for storing the network information for a handover to the mobile communication systems.

According to still yet another aspect of the present invention, an apparatus for providing handover information at a digital broadcast encoding system includes an interface for communicating with another node; a handover manager for receiving network information for a handover from a network management system through the interface, converting the received handover network information into a BIFS format, and transmitting the BIFS-format handover network information to a DMB transmitting system; and storage for storing the handover network information.

According to even yet another aspect of the present invention, a system for supporting a handover to a plurality of mobile communication systems through Digital Media Broadcasting (DMB) includes a subscriber station for obtaining network information for a handover to the mobile communication systems from a current DMB channel during wireless communication with the selected mobile communication system and, if the wireless communication with the selected mobile communication system is impossible, analyzing the obtained network information to select the best mobile communication system as a handover target to perform a corresponding handover; a network management system for generating the network information for a handover to the mobile communication systems; and a digital broadcast encoding system for receiving the handover network information from the network management system, converting the received handover network information into a BIFS format, and transmitting the BIFS-format handover network information to a DMB transmitting system.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating a network configuration of a conventional IEEE 802.16e system;

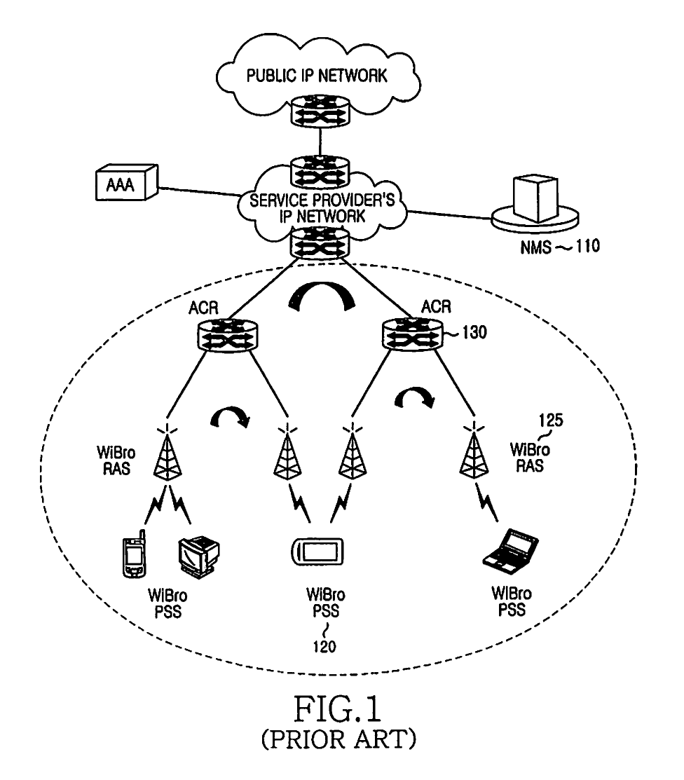

FIG. 2 is a diagram illustrating a network configuration of a DMB system and an IEEE 802.16e system according to the present invention;

FIG. 3 is a flowchart illustrating an operation of a Network Management System (NMS) according to the present invention;

FIG. 4 is a flowchart illustrating an operation of a digital broadcast encoding system according to the present invention;

FIG. 5 is a flowchart illustrating an operation of a WiBro/DMB PSS according to the present invention; and

FIG. 6 is a block diagram of the WiBro/DMB PSS, the digital broadcast encoding system, and the NMS according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

Hereinafter, a description will be given of an apparatus and method for providing handover information in a mobile communication system according to the present invention.

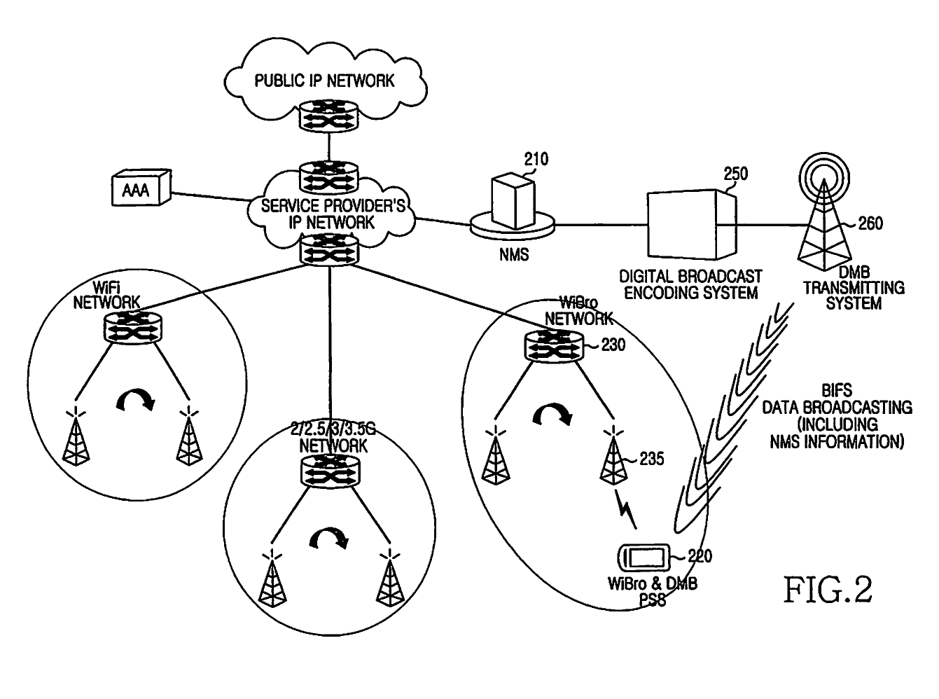

FIG. 2 is a diagram illustrating a network configuration of a DMB system and an IEEE 802.16e system according to the present invention.

Referring to FIG. 2, the present invention includes the equipment and backbone of the conventional WiBro and DMB systems.

The present invention further includes an extended Network Management System (NMS) 210 and a digital broadcast encoding system 250. The NMS 210 provides network information for a handover (hereinafter, “handover network information”). The digital broadcast encoding system 250 encodes the handover network information of the NMS 210 into a BIFS-format DMB data broadcast stream.

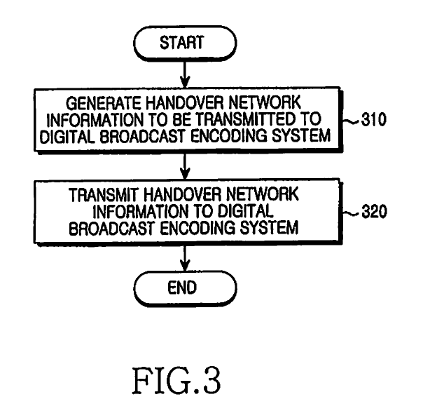

FIG. 3 is a flowchart illustrating an operation of the NMS according to the present invention.

Referring to FIG. 3, the NMS generates handover network information to be transmitted to the digital broadcast encoding system, in step 310.

In step 320, the NMS transmits the generated handover network information to the digital broadcast encoding system. Thereafter, the operation is ended.

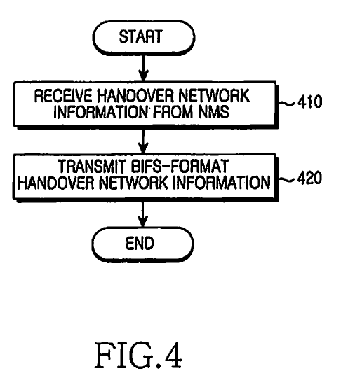

FIG. 4 is a flowchart illustrating an operation of the digital broadcast encoding system according to the present invention.

Referring to FIG. 4, the digital broadcast encoding system receives handover network information from the NMS, in step 410.

In step 420, the digital broadcast encoding system encodes the received handover network information into a BIFS format and transmits the BIFS-formatted handover network information using a DMB transmitting system 260 (see FIG. 2). Thereafter, the operation is ended.

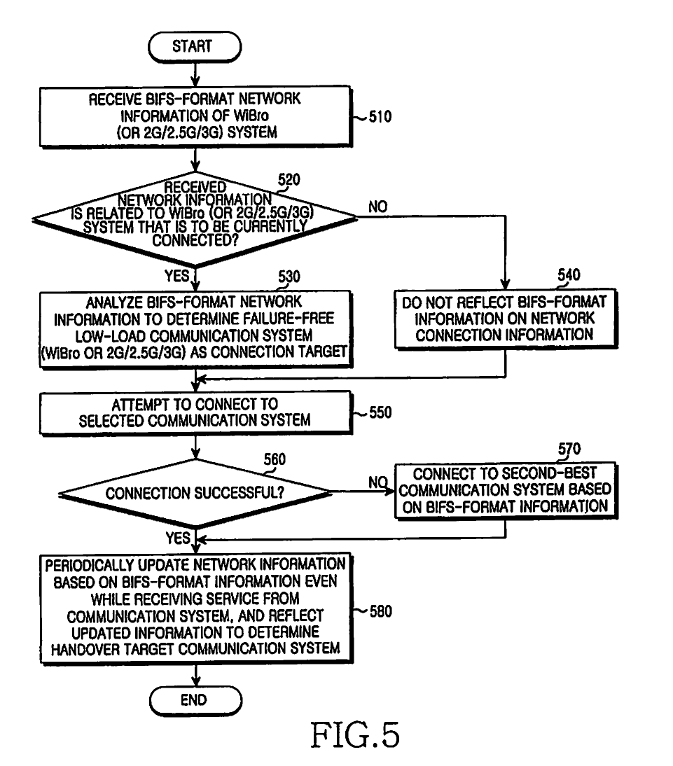

FIG. 5 is a flowchart illustrating an operation of a WiBro/DMB PSS 220 (see FIG. 2), which is an example of a subscriber station, according to the present invention. It will be assumed that the WiBro/DMB PSS receives network information about the WiBro system and different mobile communication systems using a predetermined wireless communication protocol.

Referring to FIG. 5, the WiBro/DMB PSS receives BIFS-format handover network information about the WiBro system and the different mobile communication systems, in step 510.

In step 520, the WiBro/DMB PSS determines if the contents of the network information are related to the WiBro system or another mobile communication system, which is to be currently connected by the WiBro/DMB PSS (i.e., if information about a communication system that is to be currently connected by the WiBro/DMB PSS is present in the network information). If so, the operation proceeds to step 530 and then to step 550; and if not, the operation proceeds to step 540 and then to step 550. In step 540, the WiBro/DMB PSS does not reflect the BIFS-format network information on handover information.

In step 530, the WiBro/DMB PSS analyzes the BIFS-format network information to determine a best network (i.e., a communication network having a least network failure and a smallest network load) as a connection target (i.e., a handover target communication system).

In step 550, the WiBro/DMB PSS attempts to connect to the target communication system (i.e., performs a handover).

In step 560, the WiBro/DMB PSS determines if the connection to the target communication system is successful.

If the connection to the target communication system is successful, in step 560, the WiBro/DMB PSS periodically receives and updates BIFS-format network information even while receiving a service from the connected communication system, and reflects the updated information to determine the handover target communication system, in step 580. Thereafter, the operation is ended.

On the other hand, if the connection to the target communication system is unsuccessful, in step 560, the WiBro/DMB PSS analyzes the BIFS-format network information and attempts to connect to a second-best communication system, in step 570.

Thereafter, in step 580, the WiBro/DMB PSS periodically receives and updates BIFS-format network information even while receiving a service from the second-best communication system, and reflects the updated information to determine the handover target communication system. Thereafter, the operation is ended.

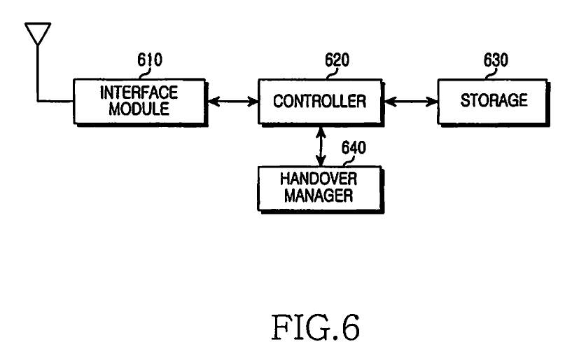

FIG. 6 is a block diagram of the WiBro/DMB PSS, the digital broadcast encoding system, and the NMS according to the present invention.

Referring to FIG. 6, the WiBro/DMB PSS includes an interface module 610, a controller 620, a storage 630, and a handover manager 640.

The interface module 610 is a module for communicating with another node, and includes a Radio-Frequency (RF) processor and a baseband processor. The RF processor converts an RF signal received through an antenna into a baseband signal, and provides the baseband signal to the baseband processor. In addition, the RF processor converts a baseband signal received from the baseband processor into an RF signal, and transmits the RF signal through the antenna. According to the present invention, the interface module 610 includes a WiBro interface module, a DMB interface module, and interfaces modules for a plurality of mobile communication systems.

The controller 620 controls an overall operation of the WiBro/DMB PSS. For example, the controller 620 processes and controls voice communication and data communication. In addition to the general functions, the controller 620 provides the handover manager 640 with BIFS-format data received through the DMB interface module.

The handover manager 640 obtains handover network information from the BIFS-format data received from the controller 620. That is, the handover manager 640 obtains network information of a plurality of mobile communication systems for handover. Thereafter, the handover manage 640 determines a handover target communication system on the basis of the obtained network information and performs a corresponding handover.

The storage 630 stores a program for controlling the overall operation of the WiBro/DMB PSS and temporary data that is generated during the execution of programs. According to the present invention, the storage 630 stores handover network information.

In the above-described configuration, the controller 620 may perform the functions of the handover manager 640. Although a separate unit (i.e., the handover manager 640) is provided for some functions of the controller 620, the controller 620 may perform all or some of the functions instead of the separate unit.

Referring again to FIG. 6, the NMS includes an interface module 610, a controller 620, a storage 630, and a handover manager 640.

The interface module 610 includes a wired communication module for communicating with another node.

The controller 620 controls an overall operation of the NMS. For example, the controller 620 monitors in real time: status data, failure data, configuration data, and statistical data on the network elements. Also, the controller 620 controls the amount of available traffic according to priority, and informs an operator when a failure occurs, for rapid treatment of the failure. In addition, on the basis of collected data, the controller 620 provides information necessary for analysis of the current network and establishment of the upcoming network strategy. According to the present invention, the controller 620 controls the handover manager 640 such that the handover manager 640 generates handover network information and transmits the generated handover network information to the digital broadcast encoding system.

The handover manager 640 generates handover network information and transmits the generated handover network information to the digital broadcast encoding system.

The storage 630 stores a program for controlling the overall operation of the NMS and temporary data that is generated during the execution of programs. According to the present invention, the storage 630 stores handover network information.

In the above-described configuration, the controller 620 may perform the functions of the handover manager 640. Although a separate unit (i.e., the handover manager 640) is provided for some functions of the controller 620, the controller 620 may perform all or some of the functions instead of the separate unit.

Referring again to FIG. 6, the digital broadcast encoding system includes an interface module 610, a controller 620, a storage 630, and a handover manager 640.

The interface module 610 includes a wired communication module for communicating with another node.

The controller 620 controls an overall operation of the digital broadcast encoding system. For example, the controller 620 encodes digital broadcast data in a predetermined format. According to the present invention, the controller 620 controls the handover manager 640 such that the handover manager 640 generates handover network information received from the NMS in a BIFS format and transmits the BIFS-format handover network information to the DMB transmitting system.

Under the control of the controller 620, the handover manager 640 generates handover network information in a BIFS format and transmits the BIFS-format handover network information to the DMB transmitting system.

The storage 630 stores a program for controlling the overall operation of the NMS and temporary data that are generated during the execution of programs. According to the present invention, the storage 630 stores handover network information.

In the above-described configuration, the controller 620 may perform the functions of the handover manager 640. Although a separate unit (i.e., the handover manager 640) is provided for some functions of the controller 620, the controller 620 may perform all or some of the functions instead of the separate unit.

As described above, using the DMB communication technology, the present invention provides network information about a plurality of communication systems for handover to the subscriber station having a plurality of communication interfaces including a DMB communication interface, thereby making it possible for the subscriber station to perform a handover from a communication system to another stable communication system when the communication system is unavailable. In addition, because the technology of the present invention can also be used for a handover in the same communication system, the subscriber station can be provided with a seamless communication service.

Alternate embodiments of the present invention can also comprise computer readable codes on a computer readable medium. The computer readable medium includes any data storage device that can store data that can be read by a computer system. Examples of a computer readable medium include magnetic storage media (such as Read-Only Memory (ROM), floppy disks, and hard disks, among others), optical recording media (such as Compact Disc (CD)-ROMs or Digital Versatile Discs (DVDs)), and storage mechanisms such as carrier waves (such as transmission through the Internet). The computer readable medium can also be distributed over network coupled computer systems so that the computer readable code is stored and executed in a distributed fashion. Also, functional programs, codes, and code segments for accomplishing the present invention can be construed by programmers of ordinary skill in the art to which the present invention pertains.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for performing a handover of a subscriber station having a wireless communication interface for Digital Media Broadcasting (DMB) and a plurality of wireless communication interfaces for a plurality of mobile communication systems, the method comprising the steps of:
performing wireless communication with one of the mobile communication systems using a corresponding wireless communication interface;
obtaining network information for a handover to the mobile communication systems from a DMB channel during the performing of the wireless communication;
if the wireless communication with one of the mobile communication systems is impossible, analyzing the network information to select a best mobile communication system as a handover target; and
performing a handover to the selected mobile communication system.

2. The method of claim 1, further comprising, if the handover to the selected mobile communication system is impossible:
analyzing the network information to select a second-best mobile communication system as a handover target; and
performing a handover to the second-best mobile communication system.

3. The method of claim 1, wherein the best mobile communication system is a mobile communication system that has a lowest amount of network failures and a smallest network load among the mobile communication systems.

4. The method of claim 1, wherein the step of obtaining the network information for a handover comprises:
receiving BInary Format for Scenes (BIFS)-formatted data over the DMB channel; and
obtaining network information for a handover to the mobile communication systems from the BIFS-format data.

5. A method for providing handover information at a network management system, the method comprising the steps of:
generating network information for a handover; and
transmitting the handover network information to a digital broadcast encoding system.

6. A method for providing handover information at a digital broadcast encoding system, the method comprising the steps of:
receiving network information for a handover from a network management system;
converting the handover network information into a BIFS format; and
transmitting the BIFS-formatted handover network information to a DMB transmitting system.

7. An apparatus for performing a handover of a subscriber station having a wireless communication interface for Digital Media Broadcasting (DMB) and a plurality of wireless communication interfaces for a plurality of mobile communication systems, the apparatus comprising:
a handover manager for obtaining network information for a handover to the mobile communication systems from the DMB wireless communication interface and, if wireless communication with a currently-connected mobile communication system is impossible, analyzing the obtained network information to select a best mobile communication system as a handover target to perform a corresponding handover; and
a storage for storing the network information for a handover to the mobile communication systems.

8. The apparatus of claim 7, wherein, if the handover to the selected mobile communication system is impossible, the handover manager analyzes the network information to select a second-best mobile communication system as a handover target to perform a corresponding handover.

9. The apparatus of claim 7, wherein the handover manager receives BInary Format for Scenes (BIFS)-format data over the DMB wireless communication interface, and obtains the network information for a handover to the mobile communication systems from the BIFS-formatted data.

10. The apparatus of claim 7, wherein the best mobile communication system is a mobile communication system that has the least network failure and the smallest network load among the mobile communication systems.

11. A system for supporting a handover to a plurality of mobile communication systems through Digital Media Broadcasting (DMB), the system comprising:
a subscriber station for obtaining network information for a handover to the mobile communication systems from a current DMB channel during wireless communication with a selected mobile communication system and, if wireless communication with the selected mobile communication system is impossible, analyzing the obtained network information to select a best mobile communication system as a handover target to perform a corresponding handover;
a network management system for generating the network information for a handover to the mobile communication systems; and
a digital broadcast encoding system for receiving the handover network information from the network management system, converting the received handover network information into a BIFS format, and transmitting the BIFS-formatted handover network information to a DMB transmitting system.

12. The system of claim 11, wherein, if the handover to the selected mobile communication system is impossible, the subscriber station analyzes the network information in order to select a second-best mobile communication system as a handover target to perform a corresponding handover.

13. The system of claim 11, wherein the subscriber station receives BIFS-formatted data over a DMB wireless communication interface, and obtains the network information for a handover to the mobile communication systems from the BIFS-formatted data.

14. The system of claim 11, wherein the best mobile communication system is a mobile communication system that has a lowest amount network failures and a smallest network load among the mobile communication systems.
